(19) United States
(12) Patent Application Publication
(10) Pub. No.: US 2024/0259827 A1
(43) Pub. Date: Aug. 1, 2024

(54) SIMULATION AND SELECTION OF A DEPLOYMENT OF NETWORK ELEMENTS

(71) Applicant: QUALCOMM Incorporated, San Diego, CA (US)

(72) Inventors: Mauro FILOMENO, Barcelona (ES); Alex BATLLE, Arenys de Munt (ES); Jordi ROS GIRALT, Vilafranca del Penedes (ES)

(21) Appl. No.: 18/161,769

(22) Filed: Jan. 30, 2023

(51) Int. Cl. H04W 16/18; H04W 24/06

(52) U.S. Cl. CPC H04W 16/18; H04W 24/06

(57) ABSTRACT

Various embodiments include methods performed by a computing device for selecting a deployment of network elements in a wireless communication network. Various embodiments may include repeating the operations of generating a candidate network deployment based on a selection of network element locations and a selection of network element types within a geographic area, simulating performance of the candidate network deployment based on the determined network demand using a bottleneck structure model, and determining whether a stop condition is satisfied by the candidate network deployment, and selecting a deployment of communication network elements according to the candidate network deployment in response to determining that the stop condition is satisfied.

### BACKGROUND

Long Term Evolution (LTE), Fifth Generation (5G) New Radio (NR), and other communication technologies enable improved communication and data services. Selection and deployment of physical infrastructure such as base stations and required backhaul communication links, for example, to upgrade or expand capabilities of a network from LTE to 5G NR, is complex and potentially very expensive. A key aspect of 5G NR networks is the use of radio frequencies in the 5 gigahertz range and above to support high speed data transmission. Such high-frequency communication links require an obstruction-free path between a base station (such as a cell tower or small cell) and user equipment (UE). Deploying network elements to provide such high-frequency communication links may require large number of base stations to provide coverage to a given area, especially in urban areas or other locales in which finding such obstruction-free paths is challenging.

### SUMMARY

Various aspects include systems and methods performed by a computing device for selecting a deployment of network elements. Various aspects may include obtaining information regarding a plurality of network element locations in a geographic area, communication characteristics of network element types suitable for deployment in the plurality of network element locations, a network demand from UEs in the geographic area, and a deployment cost of the network elements. Various aspects may include repeating the operations of: generating a candidate network deployment based on a selection of the network element locations and a selection of network element types; simulating performance of the candidate network deployment based on the determined network demand using a bottleneck structure model; and determining whether a stop condition is satisfied by the candidate network deployment. Various aspects may include selecting a deployment of communication network elements according to the candidate network deployment in response to determining that the stop condition is satisfied.

Some aspects may include modifying the candidate network deployment using an output of the bottleneck structure model to generate a next candidate network deployment in response to determining that the stop condition is not satisfied before performing the operations of simulating performance and determining whether the stop condition is satisfied. In some aspects, the network element types may include one or more of a base station, a small cell, or a repeater device. In some aspects, generating the candidate network deployment based on a selection of the network element locations and a selection of network element types may include generating the candidate network deployment further based on a selection of signal routes among network elements. In such aspects, selecting the deployment of communication network elements according to the candidate network deployment may include selecting the deployment of communication network elements further based on the selection of signal routes among the network elements.

In some aspects determining whether the stop condition is satisfied by the candidate network deployment may include determining whether the deployment cost of the network elements of the candidate network deployment meets a deployment cost condition. In some aspects determining whether the stop condition is satisfied by the candidate network deployment may include determining whether a run time condition has been satisfied. In some aspects simulating a performance of the candidate network deployment based on the determined network demand using the bottleneck structure model may include simulating a scheduling of signals by each of the network elements. In some aspects simulating a performance of the candidate network deployment based on the determined network demand using the bottleneck structure model may include using a time division water filling model for signal scheduling operations performed by one or more of the network elements. In some aspects simulating a performance of the candidate network deployment based on the determined network demand using the bottleneck structure model may include simulating a formation of beamformed signals by one or more of the network elements.

Further aspects include a computing device having a processor configured to perform one or more operations of any of the methods summarized above. Further aspects include processing devices for use in a computing device configured with processor-executable instructions to perform operations of any of the methods summarized above. Further aspects include a non-transitory processor-readable storage medium having stored thereon processor-executable instructions configured to cause a processor of a computing device to perform operations of any of the methods summarized above. Further aspects include a UE having means for performing functions of any of the methods summarized above. Further aspects include a system on chip for use in a computing device and that includes a processor configured to perform one or more operations of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1A is a system block diagram illustrating an example communications system suitable for implementing any of the various embodiments.

FIG. 1B is a system block diagram illustrating an example disaggregated base station architecture suitable for implementing any of the various embodiments.

FIG. 2 is a component block diagram illustrating an example computing and wireless modem system suitable for implementing any of the various embodiments.

FIG. 3 is a diagram illustrating elements of a simulated network deployment 300 in accordance with various embodiments.

FIGS. 4A and 4B are system block diagrams illustrating aspects of candidate network deployments 400a and 400b according to various embodiments.

FIGS. 4C-4F illustrate aspects of scheduling operations and simulations of candidate network deployments according to various embodiments.

FIG. 5A is a process flow diagram illustrating a method 500a for selecting a deployment of network elements in accordance with various embodiments.

FIG. 5B illustrates operations 500b that may be performed as part of the method 500a for selecting a deployment of network elements in accordance with various embodiments.

FIG. 6 is a component block diagram of a computing device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments enable a computing device to select an efficient deployment of network elements for a wireless communication network, such as a 5G cellular communication network. The computing device may obtain information to use as inputs such as information regarding a plurality of network element locations in a geographic area, communication characteristics of network element types suitable for deployment in the plurality of network element locations, structures in the geographic area that can degrade or block communication signals, and a network demand from UEs in the geographic area. The computing device may repeat the operations of generating a candidate network deployment based on a selection of the network element locations and a selection of network element types, simulating performance of the candidate network deployment based on the determined network demand using a bottleneck structure model, and determining whether a stop condition is satisfied by the candidate network deployment. In response to determining that the stop condition is satisfied, the computing device may select a deployment of communication network elements according to the candidate network deployment.

The term “user equipment” (UE) is used herein to refer to any one or all of wireless communication devices, wireless appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, wireless router devices, medical devices and equipment, biometric sensors/devices, wearable devices including smart watches, smart clothing, smart glasses, smart wrist bands, smart jewelry (for example, smart rings and smart bracelets), entertainment devices (for example, wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within vehicles, wireless devices affixed to or incorporated into various mobile platforms, and similar electronic devices that include a memory, wireless communication components and a programmable processor.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement Enhanced Data rates for global system for mobile communications (GSM) Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

Upgrading and/or expanding a communication network is a complex and potentially expensive endeavor. In part because 5G communication systems utilize higher frequency communication link, low obstruction or obstruction free communication paths are required. Upgrading or expanding a communication network to support 5G network elements and communication links may require the deployment of a large number of base stations (which may include macro cells, micro cells, femto cells, pico cells, repeater devices, and other suitable systems or devices that support wireless communications) to support such wireless communication links. The network topology design problem of determining an appropriate deployment of 5G network elements is nontrivial. Such design problem is NP-hard, rapidly expanding in complexity even for small size networks. For example, attempting to find an optimal solution for network deployment using brute force for a small cluster of 31 deployable poles may currently require on the order of weeks.

Various embodiments enable a computing device to rapidly simulate and select a deployment of network elements within a wireless communication network. Using as inputs information regarding a plurality of network element locations in a geographic area, communication characteristics of network element types suitable for deployment in the plurality of network element locations, a network demand from UEs in the geographic area, and a deployment cost of the network elements, the computing device may repeatedly generate a candidate network deployment based on a selection of the network element locations and a selection of network element types, simulate performance of the candidate network deployment based on the determined network demand using a bottleneck structure model, and determine whether a stop condition is satisfied by the candidate network deployment. In response to determining that the stop condition is satisfied, the computing device may select a deployment of communication network elements according to the candidate network deployment. Examples of communication characteristics include signal to noise ratio (SNR), spectral efficiency, and an angle of departure of a signal from a network element. In some embodiments, the network element types may include base stations (such as macro cells), small cells (e.g., micro cells, femto cells, pico cells), and other devices that support cellular communications that serve smaller areas than macro cells/base stations, and/or repeater devices that may retransmit or boost the gain of a signal. In some embodiments, the computing device also may obtain information about structures in the geographic area that can degrade or block communication signals. In some embodiments, determining whether a stop condition is satisfied by the candidate network deployment includes determining whether the deployment cost of the network elements of the candidate network deployment meets a deployment cost condition. In some embodiments, determining whether a stop condition is satisfied by the candidate network deployment includes determining whether a run time condition has been satisfied. In some embodiments, a run time condition may be satisfied after a defined duration of time. In some embodiments, a run time condition may be satisfied after a number of iterations or repetitions of generating a candidate network deployment based on a selection of the network element locations and a selection of network element types, and simulating performance of the candidate network deployment based on the determined network demand using a bottleneck structure model.

In some embodiments, the computing device may generate a candidate network deployment using one or more network elements that utilize scheduler devices to schedule the transmission of signals to UEs. In such embodiments, the computing device may select an angle of departure of the signal from each network element when generating the candidate network deployment. In some embodiments, the computing device may simulate a scheduling of signals by each of the network elements. In some embodiments, the computing device may use a time division water filling (TDWF) model for signal scheduling operations performed by one or more of the network elements.

In some embodiments, the computing device may generate a candidate network deployment using one or more network elements that perform beamforming operations to form a directional signal for transmissions of signals to UEs. In such embodiments, the computing device may simulate a formation of beam form signals by one or more of the network elements.

In some embodiments, the bottleneck structure model employed by the computing device may include computational graphs that characterize a state of a communication network that enable rapid simulation or modeling of a variety of network configurations to obtain information about variations in signal routing, flow scheduling, system design, task scheduling, neural network parallelization, capacity planning or resilience analysis, and other suitable information.

In various embodiments, in response to determining that the stop condition is not satisfied, the computing device may use an output of the bottleneck structure model to modify the candidate network deployment, to generate a modified or tweaked candidate network deployment (a next network deployment). The computing device may then repeat the operations of simulating a performance of the modified (next) candidate network deployment using the bottleneck structure model, and determine whether the stop condition is satisfied by the modified (next) candidate network deployment. In some embodiments, the computing device may determine the effect of small changes to a candidate network deployment without the need to generate and simulate an entirely new network deployment. In some embodiments, the computing device may compare the effects of such small changes and determine to keep such changes, or discard such changes. In some embodiments, the computing device may determine to keep such changes or discard such changes based on whether the small changes result in an improvement in one or more network performance criteria. In some embodiments, the computing device may determine to keep such changes or discard such changes based on whether a constraint is satisfied, regardless of whether the change(s) improve network performance.

Various embodiments may improve the expansion and development of wireless communication networks by enabling the rapid simulation and selection of a variety of network element deployments. Various embodiments further improve wireless communication networks by enabling the computing device to rapidly identify and select a deployment of network elements that satisfies one or more performance criteria of the communication network.

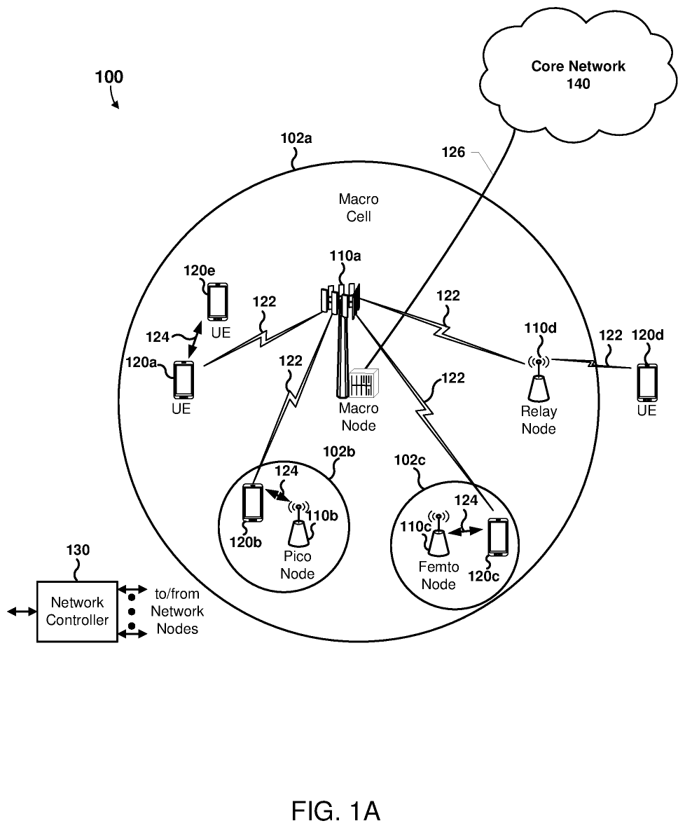

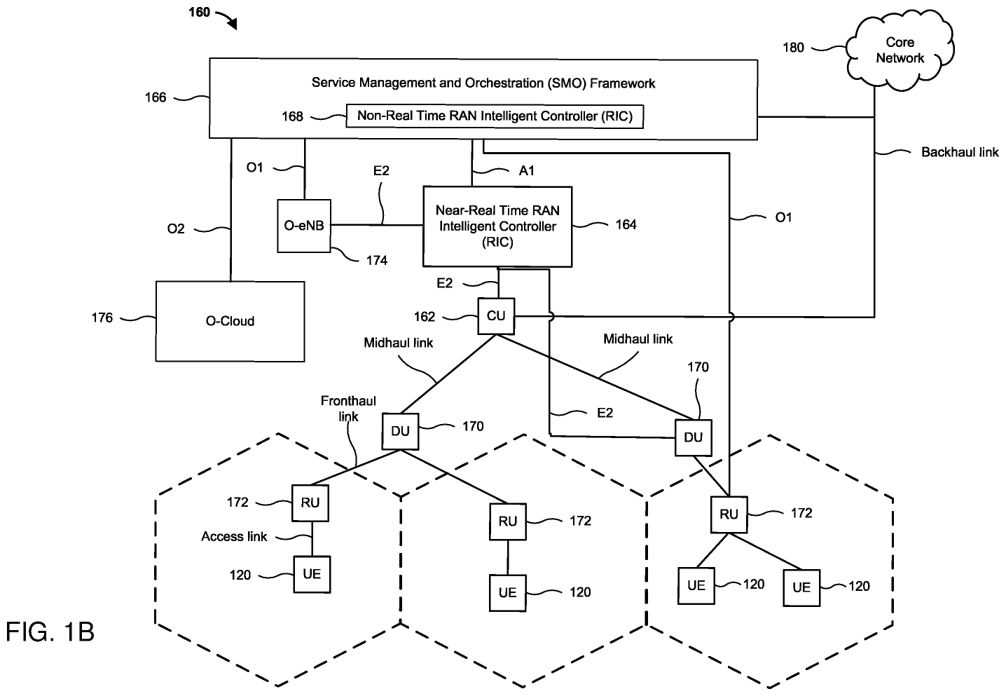

FIG. 1A is a system block diagram illustrating an example communications system 100 suitable for implementing any of the various embodiments. The communications system 100 may be a 5G New Radio (NR) network, or any other suitable network such as a Long Term Evolution (LTE) network. While FIG. 1A illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a core network 140 and a variety of UEs (illustrated as UEs 120a-120e in FIG. 1A). The communications system 100 also may include a number of network devices 110a, 110b, 110c, and 110d and other network entities, such as base stations and network nodes. A network device is an entity that communicates with UEs, and in various embodiments may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. In various communication network implementations or architectures, a network device may be implemented as an aggregated base station, as a disaggregated base station, an integrated access and backhaul (IAB) node, a relay node, a sidelink node, etc., such as a virtualized Radio Access Network (vRAN) or Open Radio Access Network (O-RAN). Also, in various communication network implementations or architectures, a network device (or network entity) may be implemented in an aggregated or monolithic base station architecture, or alternatively, in a disaggregated base station architecture, may include one or more of a Centralized Unit (CU), a Distributed Unit (DU), a Radio Unit (RU), a near-real time (RT) RAN intelligent controller (RIC), or a non-real time RIC. Each network device may provide communication coverage for a particular geographic area. In 3GPP, the term “cell” can refer to a coverage area of a network device, a network device subsystem serving this coverage area, or a combination thereof, depending on the context in which the term is used. The core network 140 may be any type core network, such as an LTE core network (e.g., an evolved packet core (EPC) network), 5G core network, etc.

A network device 110a-110d may provide communication coverage for a macro cell, a pico cell, a femto cell, another type of cell, or a combination thereof. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A network device for a macro cell may be referred to as a macro node or macro base station. A network device for a pico cell may be referred to as a pico node or a pico base station. A network device for a femto cell may be referred to as a femto node, a femto base station, a home node or home network device. In the example illustrated in FIG. 1A, a network device 110a may be a macro node for a macro cell 102a, a network device 110b may be a pico node for a pico cell 102b, and a network device 110c may be a femto node for a femto cell 102c. A network device 110a-110d may support one or multiple (for example, three) cells. The terms “network device,” “network node,” “eNB,” “base station,” “NR BS,” “gNB,” “TRP,” “AP,” “node B,” “5G NB,” and “cell” may be used interchangeably herein.

In some examples, a cell may not be stationary, and the geographic area of the cell may move according to the location of a network device, such as a network node or mobile network device. In some examples, the network devices 110a-110d may be interconnected to one another as well as to one or more other network devices (e.g., base stations or network nodes (not illustrated)) in the communications system 100 through various types of backhaul interfaces, such as a direct physical connection, a virtual network, or a combination thereof using any suitable transport network.

The network device 110a-110d may communicate with the core network 140 over a wired or wireless communication link 126. The UE 120a-120e may communicate with the network node 110a-110d over a wireless communication link 122. The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay network device 110d). A relay station is an entity that can receive a transmission of data from an upstream station (for example, a network device or a UE) and send a transmission of the data to a downstream station (for example, a UE or a network device). A relay station also may be a UE that can relay transmissions for other UEs. In the example illustrated in FIG. 1A, a relay station 110d may communicate with macro the network device 110a and the UE 120d in order to facilitate communication between the network device 110a and the UE 120d. A relay station also may be referred to as a relay network device, a relay base station, a relay, etc.

The communications system 100 may be a heterogeneous network that includes network devices of different types, for example, macro network devices, pico network devices, femto network devices, relay network devices, etc. These different types of network devices may have different transmit power levels, different coverage areas, and different impacts on interference in communications system 100. For example, macro nodes may have a high transmit power level (for example, 5 to 40 Watts) whereas pico network devices, femto network devices, and relay network devices may have lower transmit power levels (for example, 0.1 to 2 Watts).

A network controller 130 may couple to a set of network devices and may provide coordination and control for these network devices. The network controller 130 may communicate with the network devices via a backhaul. The network devices also may communicate with one another, for example, directly or indirectly via a wireless or wireline backhaul.

The UEs 120a, 120b, 120c may be dispersed throughout communications system 100, and each UE may be stationary or mobile. A UE also may be referred to as an access terminal, a terminal, a mobile station, a subscriber unit, a station, wireless device, etc.

A macro network device 110a may communicate with the communication network 140 over a wired or wireless communication link 126. The UEs 120a, 120b, 120c may communicate with a network device 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using Time Division Duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per UE. Multi-layer transmissions with up to 2 streams per UE may be supported.

Aggregation of multiple cells may be supported with up to eight serving cells. Alternatively, NR may support a different air interface, other than an OFDM-based air interface.

Some UEs may be considered machine-type communication (MTC) or evolved or enhanced machine-type communication (eMTC) UEs. MTC and eMTC UEs include, for example, robots, remote devices, sensors, meters, monitors, location tags, etc., that may communicate with a network device, another device (for example, remote device), or some other entity. A wireless computing platform may provide, for example, connectivity for or to a network (for example, a wide area network such as Internet or a cellular network) via a wired or wireless communication link. Some UEs may be considered Internet-of-Things (IoT) devices or may be implemented as NB-IoT (narrowband internet of things) devices. The UE 120a-120e may be included inside a housing that houses components of the UE 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an EPC network) in a 5G NSA network. Other example network configurations may include a 5G standalone (SA) network in which a 5G/NR RAN connects to a 5G core network.

In some implementations, two or more UEs 120a-120e (for example, illustrated as the UE 120a and the UE 120e) may communicate directly using one or more sidelink channels 124 (for example, without using a network node 110a-110d as an intermediary to communicate with one another). For example, the UEs 120a-120e may communicate using peer-to-peer (P2P) communications, device-to-device (D2D) communications, a mesh network, or similar networks, a vehicle-to-everything (V2X) protocol (which may include a vehicle-to-vehicle (V2V) protocol, a vehicle-to-infrastructure (V2I) protocol, or a similar protocol), or combinations thereof. In this case, the UE 120a-120e may perform scheduling operations, resource selection operations, as well as other operations described elsewhere herein as being performed by the network node 110a-110d.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or components) performing base station functionality, may be implemented in an aggregated or disaggregated architecture. For example, a base station (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or as a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUs, DUs and RUs also can be implemented as virtual units, referred to as a virtual central unit (VCU), a virtual distributed unit (VDU), or a virtual radio unit (VRU).

Base station-type operations or network design may consider aggregation characteristics of base station functionality. For example, disaggregated base stations may be utilized in an integrated access backhaul (IAB) network, an open radio access network (O-RAN) (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 1B is a system block diagram illustrating an example disaggregated base station 160 architecture suitable for implementing any of the various embodiments. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUS) 172 via respective fronthaul links. The RUs 172 may communicate with respective UEs 120 via one or more radio frequency (RF) access links. In some implementations, the UE 120 may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit—User Plane (CU-UP)), control plane functionality (i.e., Central Unit—Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based RAN architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via O1) or via creation of RAN management policies (such as A1 policies).

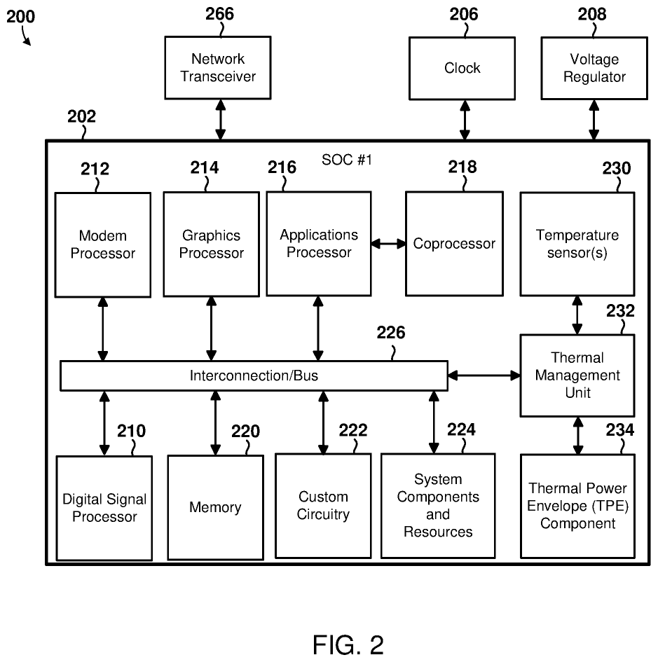

FIG. 2 is a component block diagram illustrating an example computing and wireless modem system 200 suitable for implementing any of the various embodiments. Various embodiments may be implemented on a number of single processor and multiprocessor computer systems, including a system-on-chip (SOC) or system in a package (SIP).

With reference to FIGS. 1A-2, the illustrated example computing system 200 (which may be a SIP in some embodiments) includes a two SOCs 202 coupled to a clock 206, a voltage regulator 208, and a network transceiver 266 configured to send and receive wireless communications via an antenna (not shown) to/from a UE (e.g., 120a-120e) or a network device (e.g., 110a-110d). In some implementations, the SOC 202 may operate as central processing unit (CPU) of the UE that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), and/or very high frequency short wave length (such as 28 GHz mmWave spectrum, etc.) communications.

The SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mm Wave transceivers 256, memory 258, and various additional processors 260, such as an applications processor, packet processor, etc.

Each processor 210, 212, 214, 216, 218 may include one or more cores, and each processor/core may perform operations independent of the other processors/cores. For example, the SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218 may be included as part of a processor cluster architecture (such as a synchronous processor cluster architecture, an asynchronous or heterogeneous processor cluster architecture, etc.).

The SOC 202 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the SOC 202 may include power amplifiers, voltage regulators, oscillators, phase-locked loops, peripheral bridges, data controllers, memory controllers, system controllers, access ports, timers, and other similar components used to support the processors and software clients running on a UE. The system components and resources 224 and/or custom circuitry 222 also may include circuitry to interface with peripheral devices, such as cameras, electronic displays, wireless communication devices, external memory chips, etc.

The SOC 202 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. The interconnection/bus module 226 may include an array of reconfigurable logic gates and/or implement a bus architecture (such as CoreConnect, AMBA, etc.). Communications may be provided by advanced interconnects, such as high-performance networks-on chip (NoCs).

The SOC 202 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, some implementations may be implemented in a wide variety of computing systems, which may include a single processor, multiple processors, multicore processors, or any combination thereof.

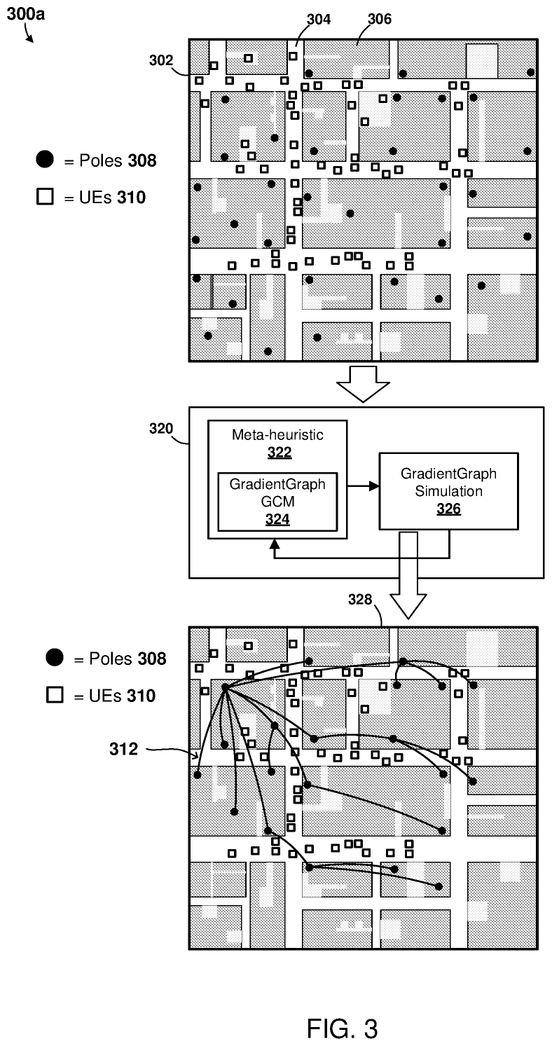

FIG. 3 is a diagram illustrating elements of a simulated network deployment 300 in accordance with various embodiments. With reference to FIGS. 1A-3, the network deployment 300 may be simulated by a processor (e.g., 210, 212, 214, 216, 218) of a computing device (e.g., 1100).

The network deployment 300 may include a geographic area 302 that may include a variety of topographical features, for example, streets 304, buildings 306, and other suitable features. The computing device may determine that the buildings 306 include a variety of aspects or characteristics, such as dimensions, materials, RF signal absorption, reflection, or transparency characteristics, a degree to which a building 306 or other structure may degrade or block communication signals, and other information on suitable for simulating a performance of a wireless communication network. The network deployment 300 may include a plurality of locations of “poles” 308 or other locations where a network element may be potentially deployed. The network deployment 300 may include a plurality of locations of UEs 310. The computing device may determine or select information about a network element deployed at or on one or more of the poles 308, such as a network element type deployed on a pole. The computing device may determine or select a network demand from the UEs 310. For example, the computing device may determine or select a minimum data throughput or another suitable measurement or metric of network demand from the UEs 310.

In various embodiments, the processor may obtain various information as inputs, and provide the inputs to an optimizer 320 that is configured to simulate performance of a candid network deployment. In some embodiments, the information obtained as inputs may include information regarding the plurality of network element locations 308, e.g., in a geographic area, communication characteristics of network element types suitable for deployment in the plurality of network element locations 308, structures in the geographic area that can degrade or block communication signals (e.g., 306), and a network demand from the UEs 310 in the geographic area.

In the optimizer 320, the processor may implement a meta-heuristic 322. The meta-heuristic 322 may receive various information as inputs. Examples of the meta-heuristic 322 may include Simulated Annealing, Markov Chain Monte Carlo, or another suitable heuristic. In some embodiments, meta-heuristic 322 may generate a candidate network deployment based on a selection of the network element locations 308 and a selection of network element types deployed at the network element locations 308. In some embodiments, the meta-heuristic 322 may generate the candidate network deployment further based on a selection of signal routes 312 among the network elements. In some embodiments, for each of the network elements, the meta-heuristic 322 may select an angle of departure of a signal from a set of feasible angles of departure at the network element locations 308. In some embodiments, the meta-heuristic 322 may use gradient information provided by a gradient computation model 324 (“GCM”) (e.g., GradientGraph GCM).

The meta-heuristic 322 may provide the candidate network deployment to a simulation module 326 (e.g., GradientGraph Simulation). The simulation module 326 may determine various aspects of a simulated performance of the candidate network deployment. For example, the simulation model 326 may provide as an output a simulated performance 328 of the candidate network deployment, including the throughput values of each UE and various aspects of a candidate network deployment. In some embodiments, the simulation model 326 may simulate a scheduling of signals by each of the network elements. In some embodiments, the simulation model 326 may use a time division water filling model for signal scheduling operations performed by the one or more of the network elements. In some embodiments, the simulation model 326 may simulate a formation of beamforming signals by one or more of the network elements.

In some embodiments, the various aspects of the performance of the candidate network deployment may be fed back into the meta-heuristic 322, and the meta-heuristic 322 may use one or more aspects of the performance of the candidate network deployment to generate (compute, select) a next candidate deployment. To generate the next candidate network deployment, the meta-heuristic 322 may make one or more random changes to the previous candidate network deployment (e.g., changes to one or more of network element locations, network element types, and/or signal routing among network elements). In some embodiments, the meta-heuristic 322 may use the information provided by the gradient computation model (gradient information) to bias a probability of selecting one or more aspects of the next candidate network deployment. In some embodiments, the bias provided by the gradient information may influence the selected changes toward one or more criteria, for example, lower cost, higher performance, or another suitable criterion. In some embodiments, the gradient computation model 324 may use delta calculations to generate the next candidate network solution based on the previous candidate network solution. In some embodiments, the gradient computation model 324 may compute gradients (derivatives) using the bottleneck structure of the network topology of each candidate network deployment. The meta-heuristic 322 may apply a bottleneck structure model to determine (compute) such gradients very quickly. In this manner, the meta-heuristic 322 may avoid calculating from scratch (i.e., may avoid performing all of the computations required to generate) a next candidate network deployment. Because the meta-heuristic 322 generates a next candidate solution that is a neighbor of (closely related to) the previous candidate network deployment, the meta-heuristic 322 may use calculations from the previous candidate network deployment.

The optimizer 320 may repeat the various operations of generating a candidate network deployment and simulating a performance of the candidate network deployment until a candidate network deployment satisfies a stop condition. The stop condition may include one or more characteristics of network performance, for example, data throughput, data rates delivered to UEs, and/or another characteristic. For example, using information about the plurality of network element locations 308, communication characteristics of network element types that may be deployed at each network element location 308, the structures in the geographic area 306 that may degrade or block communication signals, and a posited (e.g., selected, assumed, or predetermined) network demand from the UEs 310, the optimizer 320 may rapidly determine (compute) an expected data throughput provided to UEs by each network element using the bottleneck structure model. In some embodiments, successive computations in each iteration (e.g., using a simulated annealing procedure) may be performed very quickly because they may be obtained by applying small delta changes in the bottleneck structure model. In some embodiments, the simulation module 326 also may obtain (perform, calculate) gradient calculations. Gradients computed from the bottleneck structure model may be provided to the meta-heuristic 322, and may enable the meta-heuristic 322 to select one or more aspects of the next candidate network deployment, thereby increasing the probability that the next candidate network deployment is superior to the previous candidate network deployment in at least one aspect.

In some embodiments, the optimizer 320 may be configured to apply a softmax heuristic function to implement a ε-greedy-like policy, or another suitable policy, that provides a bias toward lower-cost solutions for each successive candidate network deployment. In some embodiments, the optimizer 320 also may consider additional information when generating each next candidate network deployment, such as temperature, information from previous candidate network deployments, and/or a power gradient function (e.g., which may be applied by the gradient computation model 324).

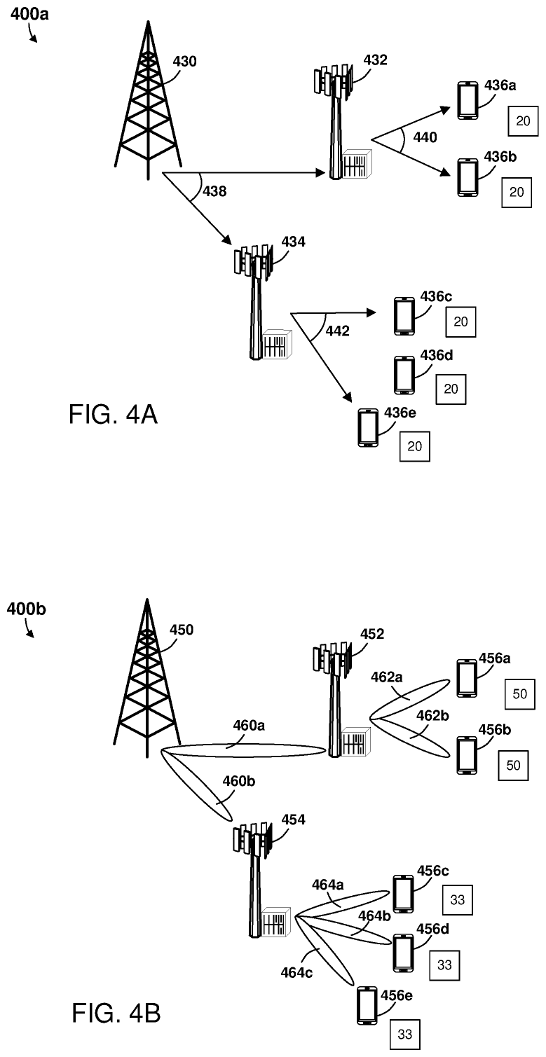

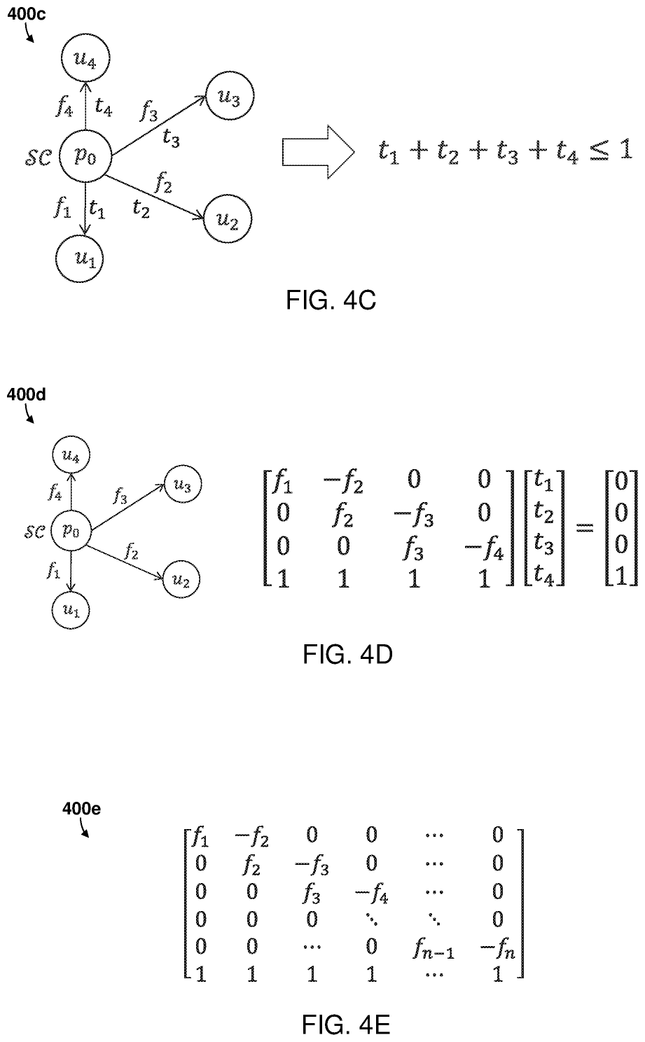

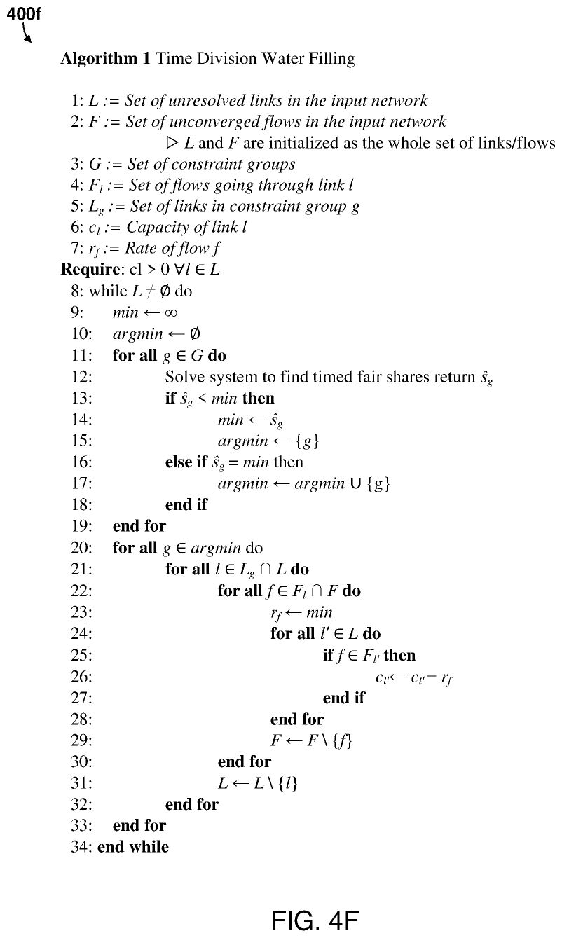

FIGS. 4A and 4B are system block diagrams illustrating aspects of candidate network deployments 400a and 400b according to various embodiments. With reference to FIGS. 1A-4B, the candidate network deployments 400a and 400b may be simulated by a processor (e.g., 210, 212, 214, 216, 218) of a computing device (e.g., 1100).

Referring to FIG. 4A, the candidate network deployment 400a includes a base station 430, small cells 432 and 434, and UEs 436a-436e. In the candidate network deployment 400a, the processor may use as inputs information such as an angle of departure of signals from one or more of the network elements. For example, signals transmitted from the base station 430 to the small cells 432 and 434 may have a first angle of departure 438. Signals transmitted from the small cell 432 to the UEs 436a and 436b may have a second angle of departure 440. Signals transmitted from the small cell 434 to the UEs 436c-436e may have a third angle of departure 442. In some embodiments, the processor may simulate a scheduling of signals by each of the network elements (i.e., the base station 430 and the small cells 432 and 434). In some embodiments, the processor may use a time division water filling model for signal scheduling operations performed by one or more of the network elements.

In various embodiments, because of time allocations, data flows may be bottlenecked at scheduler devices, such as may be simulated for the network elements 450, 452, 454. In some embodiments, the processor may apply a water-filling algorithm to model operations of such scheduler devices. In some embodiments, the water-filling algorithm may run in quadratic time with respect to a number of links in the network (in contrast to a regular water-filling algorithm that may be linear with respect to the number of links in the network). In some embodiments, such algorithm may assign time allocations to each simulated scheduler that yield a max-min solution.

Referring to FIG. 4B, the candidate network deployment 400b includes a base station 450, small cells 452 and 454, and UEs 456a-456e. In the candidate network deployment 400a, the network elements (i.e., the base station 450 and the small cells 452 and 454) use simulated beamformed signals 460a, 460b, 462a, 462b, 464a, 464b, 464c. While the candidate network deployments 400a and 400b are illustrated using exclusively scheduled signals and beamformed signals respectively, this is not a limitation, and various candidate network deployments may include a combination of network elements that transmit scheduled signals and network elements that transmit beamformed signals in any variation.

FIGS. 4C-4F illustrate aspects of scheduling operations 400c, 400d, 400e, and 400f that may be simulated for candidate network deployments according to various embodiments. With reference to FIGS. 1A-4F, the scheduling operations 400c-400f may be simulated by a processor (e.g., 210, 212, 214, 216, 218) of a computing device (e.g., 1100).

Referring to FIG. 4C, network elements have a limited amount of time to allocate to each of communication links (connections) with UEs supported by each network element. To manage time allocations, the network may include schedulers that may be functionality included with network elements on poles or separate elements in communication with network elements on poles. Schedulers may be configured to allocate communication time to each communication link. For example, a scheduler SC on a pole p₀ should allocate communication time to the associated network element so that element does not use more than 100% of available time resources. If parallelizing with n resources, the scheduler SC should not use more than 100n % of the available time resources. This constraint may be expressed as Σ_{l∈L} t₁≤n, where times are expressed as tₗ∈[0,1] for each l∈L, where L is the set of links being scheduled by SC The scheduler SC may allocate time for communication links f1, f2, f3, and f4 with each of UEs u1-u4 as t1, t2, t3, and t4, respectively. As illustrated in FIG. 4C, the total of times t1, t2, t3, and t4 is less than or equal to 1, i.e., less than or equal to 100 percent of the time resources available to the scheduler SC. In some embodiments, parallelizing may include employing beamformed signals in a way that is similar to having multiple independent base stations (or other network elements) so that each one has an independent scheduler. Each of the schedulers would then work to satisfy the less-or-equal-than-one constraint. In some embodiments, such use of beamformed signals may be represented by requiring that the sum over all time fractions (times) is less than or equal to the number of beams.

Referring to FIG. 4D, the scheduler SC may be configured to calculate or determine the time allocations for each of UEs u1-u4 such that the resulting rates satisfy leximin fairness, this is, such that the minimum rate of each communication flow is allocated the maximum allocable value. In some embodiments, a time division water-filling model may be applied to determine a minimum time fair share for each communication link, which may be represented as ŝₗ=tₗ×sₗ, in which tₗ represents a time per link, sₗ represents a fair share rate per link, and ŝₗ represents a timed fair share rate per link. The timed fair share rate may be allocated to each flow f passing through the minimum timed fair share link, which may be represented as r_{f}=ŝₗ. The processor may update capacities of the links that the flood traverses in the time division water-filling model.

Starting with the minimum value among all timed fair shares ŝₗ=tₗsₗ, the processor may, in some embodiments, determine a leximin optimality of finally-determined rates. (Starting with a value other than the minimum timed fair share may force the minimum rate to go to a lower value.) To determine fairness in the time shares allocated to each communication link, the processor may set all of the timed fair-shares tₗfₗ=tₖfₖ ∀l, k∈L_{g}, where L_{g} is the set of links associated with the scheduler. In this manner, the processor may determine a leximin optimality of the timed fair-shares such that the communication link with minimum timed fair share may be allocated the largest possible flow rate.

In various embodiments, the processor may perform one or more of the processes iteratively. In some embodiments, once every single link has been allocated a timed fair share as a rate, the processor may determine all network rates, and the processor may determine whether a stop criteria is satisfied (met, triggered). In some embodiments, in each iteration a single constraint group is resolved, and consequently every non-previously-resolved flow traversing (going through) a link of the constraint group (being regulated by the same scheduler) is resolved by setting its rate to the minimum timed fair share.

In some embodiments, the scheduler SC may be configured with an additional restriction, which may be expressed as Σ_{l∈L}_{_{g}} tₗ=1. A linear system may be formed in which all timed fair shares within the same scheduler are set to be equal, an example of which is illustrated for the scheduler SC and four communication flows f1, f2, f3, and f4 in FIG. 4E. Such a system may provide a unique solution, as may be proven by computing its determinant. As illustrated in FIG. 4E, as all rate fair-shares are positive, the determinant is always non-zero.

Referring to FIG. 4F, as noted above, in some embodiments, the computing device may use a time division water filling model for signal scheduling operations performed by one or more of the network elements. For example, a processor may implement a time division water filling algorithm 400f, or another suitable algorithm that includes similar applicable arguments, values, and operations.

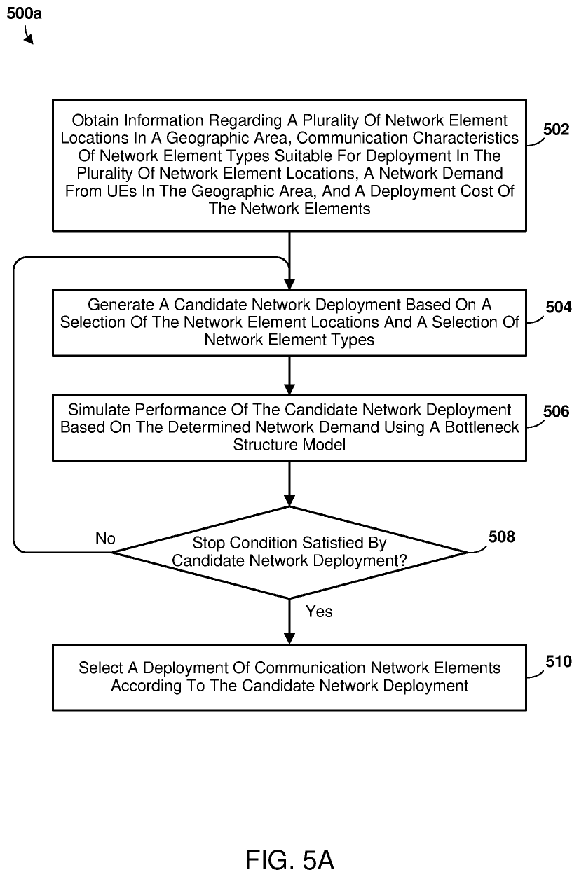

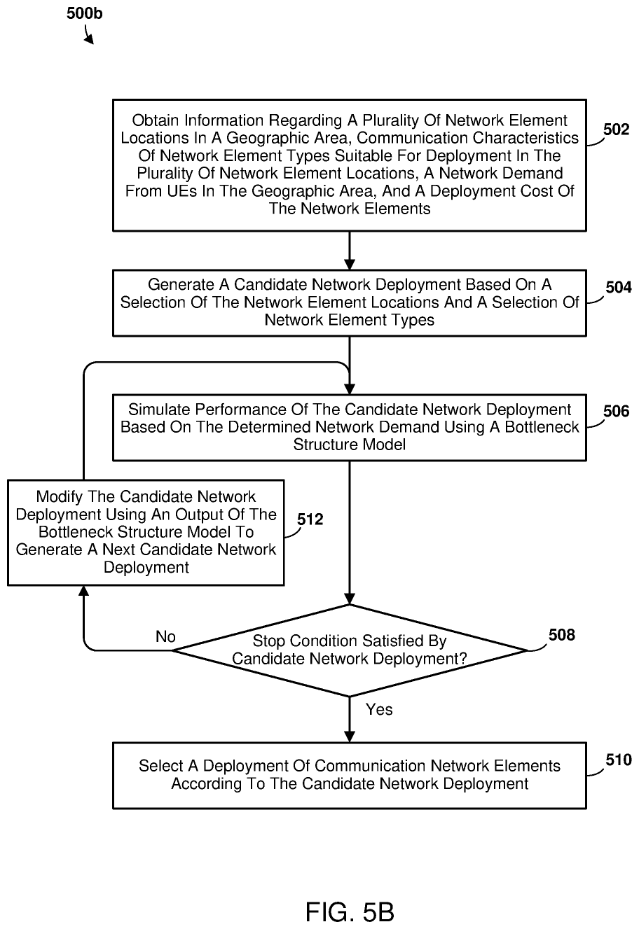

FIG. 5A is a process flow diagram illustrating a method 500a for selecting a deployment of network elements in accordance with various embodiments. With reference to FIGS. 1A-5A, the operations of the method 500a may be performed by a processor (e.g., 210, 212, 214, 216, 218) of a computing device (e.g., 1100), and is referred to generally as a “processor.”

In block 502, the processor may obtain information regarding a plurality of network element locations in a geographic area, communication characteristics of network element types suitable for deployment in the plurality of network element locations, a network demand from UEs in the geographic area, and a deployment cost of the network elements. For example, the processor may obtain information about the plurality of network element locations 408, capabilities and/or characteristics of network elements (e.g., base stations, small cells, and/or repeater devices) that may be disposed at each of the network element locations 408, structures 406, and a network demand from UEs 410. In some embodiments, the communication characteristics may include signal to noise ratio (SNR), spectral efficiency, and/or an angle of departure of a signal from a network element.

In block 504, the processor may generate a candidate network deployment (e.g., 300) based on a selection of the network element locations and a selection of network element types. In some embodiments, the network element types may include one or more of a base station, a small cell, or a repeater device. In some embodiments, the processor also may generate the candidate network deployment further based on a selection of signal routes among network elements.

In block 506, the processor may simulate performance of the candidate network deployment based on the determined network demand using a bottleneck structure model. For example, the processing may output a simulated performance (e.g., 428) of the candidate network deployment.

In some embodiments, the processor may simulate a scheduling of signals by each of the network elements. In some embodiments, the processor may use a time division water filling model for signal scheduling operations performed by one or more of the network elements. In some embodiments, the processor may simulate a formation of beamformed signals by one or more of the network elements.

In determination block 508, the processor may determine whether a stop condition is satisfied by the candidate network deployment. In some embodiments, determining whether the stop condition is satisfied by the candidate network deployment may include determining whether the deployment cost of the network elements of the candidate network deployment meets a deployment cost condition. In some embodiments, determining whether the stop condition is satisfied by the candidate network deployment includes determining whether a run time condition (such as a duration of time, or a number of iterations) has been satisfied.

In response to determining that the stop condition is not satisfied by the candidate network deployment (i.e., determination block 508=“No”), the processor may repeat the operations of generating a (next) candidate network deployment and simulating a performance of the (next) candidate network deployment in blocks 504 and 506, as described. In some embodiments, the processor may determine the effect of small changes to a candidate network deployment without the need to generate and simulate an entirely new network deployment. In some embodiments, the processor may compare the effects of such small changes, and determine whether to keep or discard such changes based on whether the small changes result in an improvement in one or more network performance criteria.

In response to determining that the stop condition is not satisfied by the candidate network deployment (i.e., determination block 508=“Yes”), the processor may select a deployment of communication network elements according to the candidate network deployment in block 510. In some embodiments, the processor may select the deployment of communication network elements in block 510 further based on the selection of signal routes among the network elements. In some embodiments, determining whether a stop condition is satisfied by the candidate network deployment includes determining whether the simulated performance of the candidate network deployment satisfies the network demand from the UEs in the geographic area. In some embodiments, the network demand from the UEs may be expressed in terms of data throughput, data rates provided to UEs, or another suitable metric, value, or expression of network demand from the UEs.

FIG. 5B illustrates operations 500b that may be performed as part of the method 500a for selecting a deployment of network elements in accordance with various embodiments. With reference to FIGS. 1A-5A, the operations of the method 500b may be performed by a processor (e.g., 210, 212, 214, 216, 218) of a computing device (e.g., 1100), and is referred to generally as a “processor.”

In some embodiments, in response to determining that the stop condition is not satisfied by the candidate network deployment (i.e., determination block 508=“No”), the processor may modify the candidate network deployment using an output of the bottleneck structure model to generate a next candidate network deployment in block 512. For example, the processor may use an output of the bottleneck structure model to modify the candidate network deployment, to generate a modified or tweaked candidate network deployment (a next network deployment). In some embodiments, the processor may determine the effect of small changes to a candidate network deployment without the need to generate and simulate an entirely new network deployment. In some embodiments, the processor may compare the effects of such small changes, and determine whether to keep or discard such changes based on whether the small changes result in an improvement in one or more network performance criteria.

Following performance of the operations of block 512, the processor may simulate performance of the modified candidate network deployment in block 506 and perform the operations determination block 508 and 510 as described.

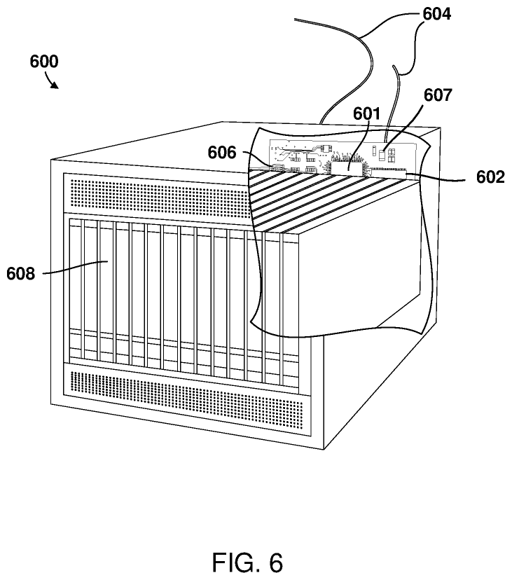

FIG. 6 is a component block diagram of a computing device 600 suitable for use with various embodiments. Such computing devices may include at least the components illustrated in FIG. 6. With reference to FIGS. 1A-6, the computing device 600 may typically include a processor 601 coupled to volatile memory 602 and a large capacity nonvolatile memory, such as a disk drive 608. The computing device 600 also may include a peripheral memory access device 606 such as a floppy disc drive, compact disc (CD) or digital video disc (DVD) drive coupled to the processor 601. The computing device 600 also may include network access ports 604 (or interfaces) coupled to the processor 601 for establishing data connections with a network, such as the Internet or a local area network coupled to other system computers and servers. The computing device 600 may include one or more antennas 607 for sending and receiving electromagnetic radiation that may be connected to a wireless communication link. The computing device 600 may include additional access ports, such as USB, Firewire, Thunderbolt, and the like for coupling to peripherals, external memory, or other devices.

The processors of the UE 600 and the network device 600 may be any programmable microprocessor, microcomputer or multiple processor chip or chips that can be configured by software instructions (applications) to perform a variety of functions, including the functions of some implementations described below. Software applications may be stored in the memory 602 before they are accessed and loaded into the processor. The processors may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the methods and operations disclosed herein may be substituted for or combined with one or more operations of the methods and operations disclosed herein.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples;

the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.
Example 1. A method of selecting a deployment of network elements, including obtaining information regarding a plurality of network element locations in a geographic area, communication characteristics of network element types suitable for deployment in the plurality of network element locations, a network demand from user equipment (UEs) in the geographic area, and a deployment cost of the network elements, repeating the operations of generating a candidate network deployment based on a selection of the network element locations and a selection of network element types, simulating performance of the candidate network deployment based on the determined network demand using a bottleneck structure model, and determining whether a stop condition is satisfied by the candidate network deployment, and selecting a deployment of communication network elements according to the candidate network deployment in response to determining that the stop condition is satisfied.
Example 2. The method of example 1, further including modifying the candidate network deployment using an output of the bottleneck structure model to generate a next candidate network deployment in response to determining that the stop condition is not satisfied before performing the operations of simulating performance and determining whether the stop condition is satisfied.
Example 3. The method of either of examples 1 or 2, wherein the network element types include one or more of a base station, a small cell, or a repeater device.
Example 4. The method of any of examples 1-3, wherein generating the candidate network deployment based on a selection of the network element locations and a selection of network element types includes generating the candidate network deployment further based on a selection of signal routes among network elements, and selecting the deployment of communication network elements according to the candidate network deployment includes selecting the deployment of communication network elements further based on the selection of signal routes among the network elements.
Example 5. The method of any of examples 1-4, wherein determining whether the stop condition is satisfied by the candidate network deployment includes determining whether the deployment cost of the network elements of the candidate network deployment meets a deployment cost condition.
Example 6. The method of any of examples 1-5, wherein determining whether the stop condition is satisfied by the candidate network deployment includes determining whether a run time condition has been satisfied.
Example 7. The method of any of examples 1-6, wherein simulating a performance of the candidate network deployment based on the determined network demand using the bottleneck structure model includes simulating a scheduling of signals by each of the network elements.
Example 8. The method of any of examples 1-7, wherein simulating a performance of the candidate network deployment based on the determined network demand using the bottleneck structure model includes using a time division water filling model for signal scheduling operations performed by one or more of the network elements.
Example 9. The method of any of examples 1-8, wherein simulating a performance of the candidate network deployment based on the determined network demand using the bottleneck structure model includes simulating a formation of beamformed signals by one or more of the network elements.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running in a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020TM), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of selecting a deployment of network elements, comprising:
obtaining information regarding a plurality of network element locations in a geographic area, communication characteristics of network element types suitable for deployment in the plurality of network element locations, a network demand from user equipment (UEs) in the geographic area, and a deployment cost of the network elements;
repeating the operations of:
generating a candidate network deployment based on a selection of the network element locations and a selection of network element types;
simulating performance of the candidate network deployment based on the determined network demand using a bottleneck structure model; and
determining whether a stop condition is satisfied by the candidate network deployment; and
selecting a deployment of communication network elements according to the candidate network deployment in response to determining that the stop condition is satisfied.

2. The method of claim 1, further comprising:
modifying the candidate network deployment using an output of the bottleneck structure model to generate a next candidate network deployment in response to determining that the stop condition is not satisfied before performing the operations of simulating performance and determining whether the stop condition is satisfied.

3. The method of claim 1, wherein the network element types comprise one or more of a base station, a small cell, or a repeater device.

4. The method of claim 1, wherein:
generating the candidate network deployment based on a selection of the network element locations and a selection of network element types comprises generating the candidate network deployment further based on a selection of signal routes among network elements; and
selecting the deployment of communication network elements according to the candidate network deployment comprises selecting the deployment of communication network elements further based on the selection of signal routes among the network elements.

5. The method of claim 1, wherein determining whether the stop condition is satisfied by the candidate network deployment comprises determining whether the deployment cost of the network elements of the candidate network deployment meets a deployment cost condition.

6. The method of claim 1, wherein determining whether the stop condition is satisfied by the candidate network deployment comprises determining whether a run time condition has been satisfied.

7. The method of claim 1, wherein simulating a performance of the candidate network deployment based on the determined network demand using the bottleneck structure model comprises simulating a scheduling of signals by each of the network elements.

8. The method of claim 1, wherein simulating a performance of the candidate network deployment based on the determined network demand using the bottleneck structure model comprises using a time division water filling model for signal scheduling operations performed by one or more of the network elements.

9. The method of claim 1, wherein simulating a performance of the candidate network deployment based on the determined network demand using the bottleneck structure model comprises simulating a formation of beamformed signals by one or more of the network elements.

10. A computing device, comprising:
a processor configured with processor-executable instructions to:
obtain information regarding a plurality of network element locations in a geographic area, communication characteristics of network element types suitable for deployment in the plurality of network element locations, a network demand from user equipment (UEs) in the geographic area, and a deployment cost of the network elements;
repeat the operations of:
generating a candidate network deployment based on a selection of the network element locations and a selection of network element types;
simulating performance of the candidate network deployment based on the determined network demand using a bottleneck structure model; and
determining whether a stop condition is satisfied by the candidate network deployment; and
select a deployment of communication network elements according to the candidate network deployment in response to determining that the stop condition is satisfied.

11. The computing device of claim 10, wherein the processor is further configured with processor-executable instructions to:
modify the candidate network deployment using an output of the bottleneck structure model to generate a next candidate network deployment in response to determining that the stop condition is not satisfied before performing the operations of simulating performance and determining whether the stop condition is satisfied.

12. The computing device of claim 10, wherein the network element types comprise one or more of a base station, a small cell, or a repeater device.

13. The computing device of claim 10, wherein the processor is further configured with processor-executable instructions to:
generate the candidate network deployment further based on a selection of signal routes among network elements; and
select the deployment of communication network elements further based on the selection of signal routes among the network elements.

14. The computing device of claim 10, wherein the processor is further configured with processor-executable instructions to determine whether the deployment cost of the network elements of the candidate network deployment meets a deployment cost condition.

15. The computing device of claim 10, wherein the processor is further configured with processor-executable instructions to determine whether a run time condition has been satisfied.

16. The computing device of claim 10, wherein the processor is further configured with processor-executable instructions to simulate a scheduling of signals by each of the network elements.

17. The computing device of claim 10, wherein the processor is further configured with processor-executable instructions to use a time division water filling model for signal scheduling operations performed by one or more of the network elements.

18. The computing device of claim 10, wherein the processor is further configured with processor-executable instructions to simulate a formation of beamformed signals by one or more of the network elements.

19. A computing device, comprising:
means for obtaining information regarding a plurality of network element locations in a geographic area, communication characteristics of network element types suitable for deployment in the plurality of network element locations, a network demand from user equipment (UEs) in the geographic area, and a deployment cost of the network elements;
means for repeating the operations of:
generating a candidate network deployment based on a selection of the network element locations and a selection of network element types;
simulating performance of the candidate network deployment based on the determined network demand using a bottleneck structure model; and
determining whether a stop condition is satisfied by the candidate network deployment; and
means for selecting a deployment of communication network elements according to the candidate network deployment in response to determining that the stop condition is satisfied.

20. The computing device of claim 19, further comprising:
means for modifying the candidate network deployment using an output of the bottleneck structure model to generate a next candidate network deployment in response to determining that the stop condition is not satisfied before performing the operations of simulating performance and determining whether the stop condition is satisfied.
